(19) United States
(12) Patent Application Publication
(10) Pub. No.: US 2001/0053691 A1
(43) Pub. Date: Dec. 20, 2001

(54) Method and arrangement for distributing, executing and consuming recreational applications in and between mobile telecommunication devices

(76) Inventor: Esa Harma, Salo (FI)

Correspondence Address: PERMAN & GREEN, 425 POST ROAD, FAIRFIELD, CT, 06430, US

(21) Appl. No.: 09/881,452

(22) Filed: Jun. 14, 2001

(30) Foreign Application Priority Data
Jun. 15, 2000 (FI) 20001425

(51) Int. Cl. H04M 3/00

(52) U.S. Cl. 455/419; 455/414

(57) ABSTRACT

A method and arrangements are provided for distributing a recreational application within a group of terminal arrangements (1101, 1102). The group comprises at least two terminal arrangements and each terminal arrangement comprises a terminal of a cellular radio system. Within the method, there is transmitted from a first terminal arrangement to a second terminal arrangement a proposal (104, 204, 704) for setting up a session of utilizing a recreational application. Only after the second terminal arrangement has received said proposal, one used (107, 108, 207, 208, 308, 408, 409, 508, 509, 510, 607, 608, 609, 610, 611, 707, 710, 711) the communicational capabilities of at least one of the first and second terminal arrangements to establish a state where both the first terminal arrangement and the second terminal arrangement possess enough software components (1103, 1104, 1105, 1106, 1205) for setting up a common, shared session of utilizing said recreational application.

### TECHNOLOGICAL FIELD

The invention concerns generally the use of mobile telecommunication devices for recreational purposes. Expecially the invention concerns the adaptation of mobile telecommunication devices for obtaining, distributing and executing certain pieces of software and content required to run recreational applications such as simulated board games or electronically stored music or literary works.

### BACKGROUND OF THE INVENTION

Mobile telecommunication devices are evolving from wireless telephones towards multifunctional personal digital assistants with diverse communication capabilities both locally and globally. One of the features introduced into mobile telecommunication devices recently before the priority date of this patent application is the possibility of playing recreational games by using the same user interface which is used for the main functions of the device. As an example we will describe the so-called worm game which can be played for example in certain mobile telephone models manufactured by the Nokia Corporation.

The telephone version of the worm game is a software module which the processor of the mobile telephone may execute as a response to an initiation command given by the user. The processor uses the small liquid crystal display of the telephone to display a field limited by edges and obstacles. A moving fraction line within the field denotes a “worm”. The worm advances at a certain speed into its local ahead direction, which is one of the four principal directions (up, down, left, right), and the user may instruct it to turn in steps of 90 degrees by pressing some of the numerical keys of the telephone.

Two users can play the worm game against each other through using the local wireless communication ports (the infrared transceivers) of their mobile telephones. In the two-player version there are two worms on the field simultaneously. Each player controls one of the worms. Each mobile telephone conveys the worm control commands given by its user to the other mobile telephone so that an exact replica of the field with the same instantaneous location and speed of the worms appears on the displays of both mobile telephones.

The worm game is only an example of known recreational applications designed for mobile telecommunication devices. Basically the manufacturer of the device may store an arbitrary game into the memory of the device in the form of processor-executable instructions. The limiting factors that have to be considered are only the size of the storage capacity that can be allocated for the recreational applications and the limited input/output characteristics of the user interface.

There are also portable terminals built especially for the purpose of playing recreational games. A widely known example of these is the Nintendo Gameboy pocket console (Nintendo and Gameboy are registered trademarks), which has also some local communicational capability in the form of an infrared transceiver and a wired serial port.

In addition to games, there are other recreational objects that may fall within the scope of the present invention. Such other recreational objects include but are not limited to electronically stored musical pieces, electronically stored literary works such as books, newspapers, magazines and parts thereof, electronically stored visual objects such as films and animations and parts thereof, and multimedia-like combinations of those mentioned above. In this patent application such other recreational objects are meant to fall within the scope of the term “recreational application”.

The disadvantage of the conventional recreational software- and recreational application solutions is their inflexibility especially regarding distribution. The user gets easily bored with the preprogrammed standard selection of games, so there should be the possibility to download other recreational applications from somewhere. It is known at the priority date of the present patent application that software applications and updates can be downloaded into mobile telecommunication devices through the radio interface from the cellular radio network. However, the known downloading arrangements are typically not optimized for downloading recreational applications, which may make their use for that purpose inconvenient. In dedicated playing consoles like the Nintendo Gameboy the loading of a new game requires the user to acquire a new memory module where the new game is permanently stored.

### SUMMARY OF THE INVENTION

It is an object of the invention to present a method and an arrangement for distributing and executing recreational applications in mobile telecommunciation devices in an easy and convenient manner. It is another object of the invention to especially adapt the distribution and execution of recreational applications to the specific needs arising from games where two or more players may take part simultaneously.

The objects of the invention are achieved by providing different versions of certain recreational applications with regard to rights of use and using the communication capabilities of the mobile telecommunication devices to arrange the distribution of the versions. Certain objects of the invention are also achieved by providing an agent program which guides a player in playing and monitors certain characteristics of the game. Certain further objects of the invention are achieved by making the usability of a recreational application that has been shared between at least two mobile telecommunication devices dependent on the physical distance between said at least two mobile telecommunication. Such physical distance has most typically a manifestation in a possibility or impossibility of using certain transmission means to exchange information between the mobile telecommunication devices.

The invention applies to a method for distributing a recreational application within a group of terminal arrangements, where the group comprises at least two terminal arrangements and each terminal arrangement comprises a terminal of a cellular radio system. The method is characterised by what is said in the characterising portion of the independent patent claim directed to a method.

The invention applies also to a terminal arrangement which is characterised by what is said in the characterising portion of the independent patent claim directed to an arrangement.

A feature which distinguishes mobile telecommunication devices from other portable electronic equipment which are used for executing and consuming recreational applications is the mobile telecommunication devices' superior capability of communicating with other devices, such as other mobile telecommunication devices and fixed servers coupled to communication networks. According to a first aspect of the invention this communication capability is harnessed for the purpose of distributing recreational applications or parts thereof in a situation where two or more players want to take part in a common session of using a recreational application. One device acts as an initiator and invites at least one other device to take part in the session. Only one of the devices, typically the initiator, must initially possess the application software or a certain key component thereof. The device initially possessing the application software or key component thereof either communicates it to the other device(s) through a local link or a communications network, or it instructs the other device(s) to download the application software or key component thereof from a certain network resource.

Acquiring and/or using a certain recreational application is typically subject to charge paid to the original designer and/or owner of rights of the application. We assume that the copy of the recreational application or key component thereof which was initially possessed by one of the devices is legal: the user of the device has paid the associated fees, if any, and consequently has a legal right to use the application. In order to prevent the above-described distributing process from being used for illegal duplicating, we may require that the recreational application or key component thereof so distributed has limited usability in the sense that it can only be used for setting up a common session with the device from which or with the help of which it was obtained. Alternatively we may define that the process of distributing a recreational application or key component thereof from a certain first device to another device causes the transmission of a payment or a piece of invoicing information to the original designer and/or owner of rights of the application. A yet further alternative is to allow the user of a device to share a recreational application or a piece thereof with the users of other devices that are physically close enough to the “originator” device so that communication between two devices through a certain short-distance communications connection is possible. After the distance between the devices grows longer than a predefined threshold value, the “follower” devices are deprived of the right to execute or consume the recreational application.

According to a second aspect of the invention the recreational application consists of a piece of passive information which may be called the definition of a field, and an active part which we denote as the agent. Several tasks that relate to the execution of the recreational application may be given to the agent. Examples of such tasks comprise but are not limited to checking the obedience to rules in association with moves made by the participants, assisting the participants in making advantageous moves, storing and analysing information related to different strategies of using the recreational application, and arranging the exchange of information between devices during a bi- or multilateral session of using the recreational application.

### BRIEF DESCRIPTION OF DRAWINGS

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

FIG. 1 illustrates the application of a first embodiment of the invention,

FIG. 2 illustrates the application of a second embodiment of the invention,

FIG. 3 illustrates the application of a third embodiment of the invention,

FIG. 4 illustrates the application of a fourth embodiment of the invention,

FIG. 5 illustrates the application of a fifth embodiment of the invention,

FIG. 6 illustrates the application of a sixth embodiment of the invention,

FIG. 7 illustrates the application of a seventh embodiment of the invention,

FIG. 8 illustrates a first alternative of imposing charges,

FIG. 9 illustrates a second alternative of imposing charges,

FIG. 10 illustrates a third alternative of imposing charges,

FIG. 11 illustrates a high-level block diagram of two terminal arrangements,

FIG. 12 illustrates an alternative high-level block diagram of two terminal arrangements,

FIG. 13 illustrates a block diagram of a recreational application,

FIG. 14 illustrates a method executed by a terminal arrangement according to an embodiment of the invention,

FIG. 15 illustrates a method executed by a terminal arrangement according to another embodiment of the invention,

FIG. 16a illustrates a block diagram of a terminal arrangement according to an embodiment of the invention and

FIG. 16b illustrates a block diagram of a terminal arrangement according to another embodiment of the invention.

### DETAILED DESCRIPTION OF THE INVENTION

The invention is meant to be equally applicable regardless of the nature of the recreational application involved. As a first basic assumption known as the “game” we may assume that the recreational application concerned involves a certain degree of interactiveness between at least two opponents, at least one of which is not a computer. There is a certain domain of activity where the actions of the users manifest themselves in the form of changing relations between the elements of which the domain of activity consists. Certain rules define the allowable actions for the users. The domain of activity and the elements thereof are typically virtual in the sense that they only exist as digital (or partly analog) values in the memory of at least one electronic device. As a second, alternative basic assumption known as the “content” we may assume that the recreational application concerned involves an electronically stored copyright-protected piece of work, such as a piece of music, a book, a newspaper, a magazine, a film, an animation or a part or combination of those mentioned above.

As an example of a recreational application of the first kind we will consider a virtual board game. In that case the domain of activity consists of a virtual board and a number of virtual pieces. The board is a data structure that comprises a number of allowed locations for the pieces. Each location can usually be individually addressed through a certain addressing scheme which has typically a matrix form with rows and columns so that each intersection between a row and a column is an allowed location. The board may naturally have more dimensions than two; the addressing matrix must have a corresponding number of dimensions. The pieces may be differently valued and may belong to different players, or at least some of them may be unclaimed. In a static situation each piece is located either at a certain allowed location on the board or in a reserve for used and/or unused pieces. The reserves may be limited or unlimited regarding the number of pieces with certain value.

The rules of the game define at least the allowable ways of moving the pieces between locations, the distribution of playing turns and the conditions of winning or losing the game. A typical playing turn means that a certain player moves at least one piece from its old location to a new location. The move may cause consequences, like that piece being “eaten” or set aside which was previously in said new location or the value of the moved piece or some other piece being changed as a result of reaching a certain decisive location. The game does not need to stay in a static situation between the playing turns of the players: the electronic devices through which the game is played may change the relations between the pieces or the nature of the board automatically in a regular or sporadic fashion. As an example of regular automatic changing one might consider the automatic forward movement of the worms in the worm game mentioned in the description of prior art.

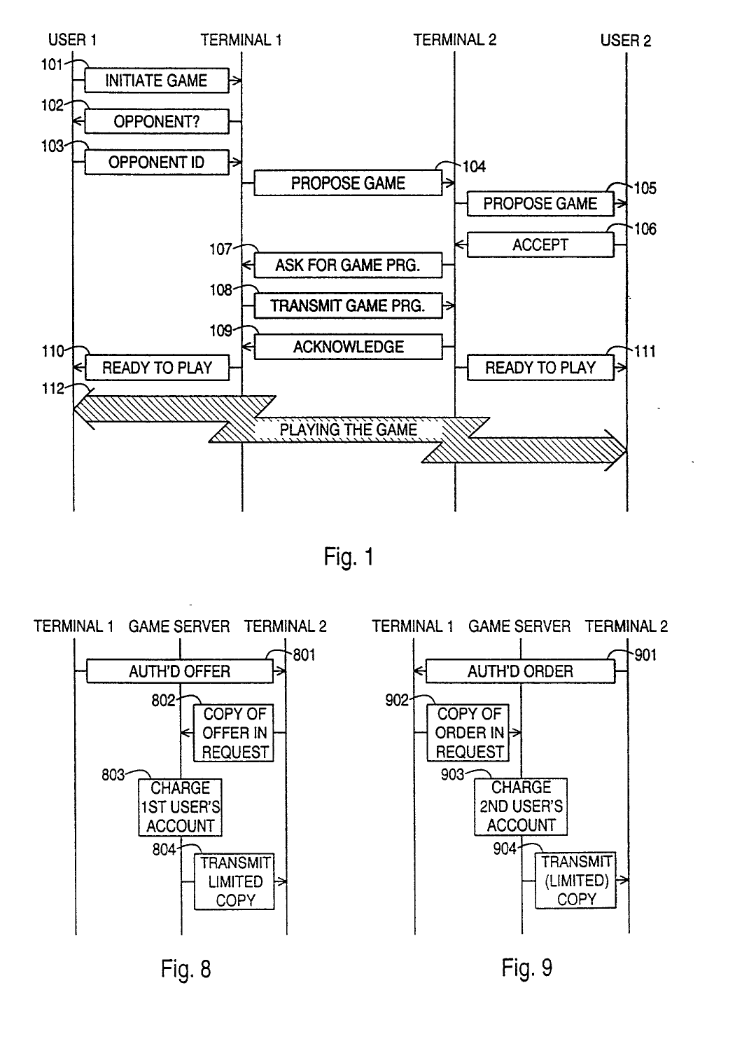

FIG. 1 illustrates a situation where a first user wants to utilize his first terminal for playing a game against a second user using a second terminal. We assume that at least one of said users is not a computer. At step 101 the first user initiates the procedure which aims at playing the game. The initiation consists typically of the first user selecting the game function from a certain menu or list of available functions. At step 102 the first terminal inquires, which opponent the first user would like to play against. In known electronic solitaire games the first user plays against his own terminal. This possibility may be available for the user even in the case illustrated in FIG. 1, but in order to describe the applicability of the present invention we assume that at step 103 the first user either keys in an identifier of the second user's terminal or selects the second user from a list of proposed candidate opponents. Taken that the terminals are mobile telecommunication devices we may assume that such a list may be the same as the first user's telephone directory or a part thereof. If the game is going to be played locally, the first user may even instruct the first terminal to propose the game to be played against any user the terminal of which is the first to answer a locally announced open call for playing. Later on we will describe the generalisation of the scheme presented in FIG. 1 to multilateral sessions where more than two players take part in the game.

Irrespective of the way in which the first user identified the second user (or the second user's terminal), at step 104 the first terminal transmits to the second terminal a proposal to play the game. The form and content of the proposal as well as the route through which the proposal is transmitted are not important from the viewpoint of the present invention. The proposal may be transmitted locally through a local link such as an infrared communication link or a wired link, or it may be transmitted even to completely another part of the world through worldwide communication networks. A non-locally transmitted proposal may take the form of an SMS message (Short Messaging Service), an MMS message (Multimedia Messaging Service), an electronic mail message, a data call, a packet-switched communication connection or any other form of connection. Typically the proposal comprises some identification information of the first user, as well as the name or other identifier of the game the playing of which is proposed. It may also comprise additional information, such as a skill rating of the first user or a capability description of the first terminal which sets a limit to the complexity of some computational and/or presentation-related tasks concerning the game.

After having received the proposal for playing the game, the second terminal produces at step 105 an indication to the second user so that the second user may decide, whether he wants to take part in the game. If the second user does not accept the proposal, he simply does not react at all or gives a negative answer. In that case the second terminal either does not transmit any response to the first terminal, or it transmits a negative response; in either case the procedure terminates after the first terminal has either received a negative response or deduced from the expiration of a time limit that the proposal was turned down. However, we assume in FIG. 1 that the second user accepts the proposal and makes his acceptance known to the second terminal at step 106.

If both the first and second terminal already possessed all necessary software components for conducting the game, the game would begin after step 106 with the second terminal indicating its readiness to the first terminal. However, in FIG. 1 we assume that the second terminal either did not have the playing software stored at all before receiving the proposal to play, or at least some key component of the software, like a decryption key or a set of instructions, was missing. So, in order to make it possible to run the playing software in the second terminal, the second terminal transmits at step 107 a request for the software or the missing component to the first terminal. The form, contents and routing of the request are as freely selectable as was described previously regarding the proposal to play transmitted in the other direction at step 104. When the first terminal has received the request, it transmits the software or the missing component thereof to the second terminal at step 108.

Transmitting a piece of software between two or more terminals typically consumes much more communication resources than transmitting simply a proposal or acceptance message. This should be kept in mind when selecting the route for the transmission at step 108. The transmission may use the same route which was used for the proposal at step 104, or it may use a different route. Even if the route itself were the same, certain communication characteristics like bandwidth reserved or modulation method chosen may be different in order to provide more throughput in the units of bits per second for the transmission of the software.

After the transmission is complete and the second terminal has received and stored the appropriate pieces of information that make it capable of running the playing software, it sends at step 109 an acknowledgement message to the first terminal. The reception of the acknowledgement message at the first terminal causes the terminal to announce to the first user at step 110 that playing may begin. The second terminal gives a similar indication to the second user at step 111. Thereafter the actual playing of the game may start: it involves typically the repeated exchange of messages where the players announce their moves. This step is generally represented in FIG. 1 as 112. We will return later to the role of the agent, which is associated with a certain aspect of the invention, during step 112.

The procedure of FIG. 1 could be simplified if the first terminal transmitted already within the proposal to play at step 104 also the playing software or the missing key components thereof to the second terminal. In such a case the steps 107 and 108 would not be needed at all. If the second user accepted the proposal at step 106, the acknowledgement to the first terminal could be transmitted immediately; if not, the second terminal would simply discard the received playing software. However, such a simplification would considerably increase the use of communication resources between the first and second terminals, because however simple a game, the corresponding software or even only a key component thereof is likely to consume much more communication resources than just a simple proposal message. All resources used for proposal+downloading transmissions which do not lead to playing the game would be wasted.

In the foregoing we assumed that the first terminal is the source for downloading the playing software or key component thereof to the second terminal. We may designate such an embodiment of the invention as the “Would you play this game with me” embodiment. However, in many cases it may prove to be more advantageous to use an external data source for downloading. From prior art downloadable recreational applications there is known the concept of having the actual applications stored in a server somewhere in a communications network. Terminals that wish to download a certain recreational application make a request to said server, and in return they obtain the requested recreational application or the parts of software that are required in order to make an already existing other part of software usable.

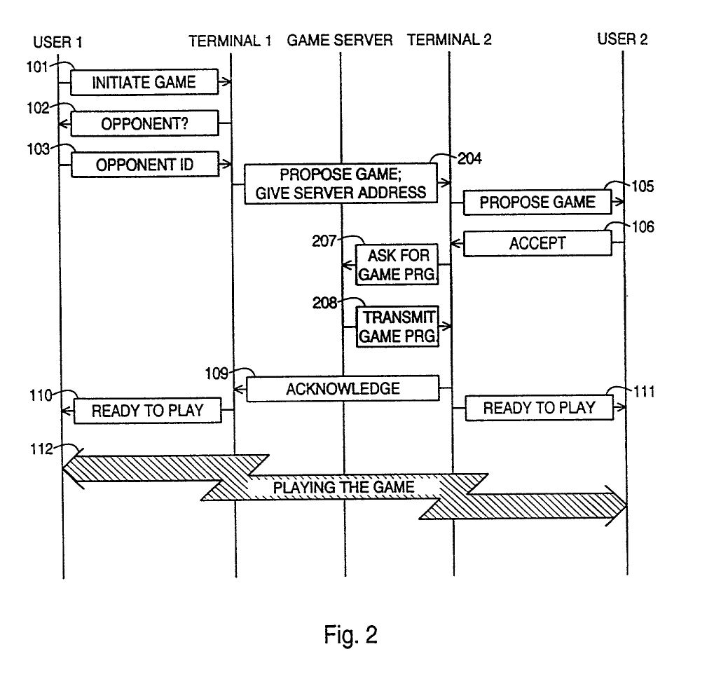

FIG. 2 illustrates an application of an embodiment of the present invention where the principle of downloading recreational software from a server is applied. This embodiment is designated as the “Get a game like this so we can play” embodiment. Steps 101, 102 and 103 are the same as in FIG. 1. However, at step 204, together with the proposal for playing the game the first terminal transmits to the second terminal the network address, telephone number for data calls or SMS messages, dynamic Internet Protocol address link, or other contact information of the server from which the playing software or key component thereof may be downloaded. In the following we will use the designation “network address” to denote any form of contact information.

Informing the second terminal about the network address requires naturally that the first terminal is aware of such a network address. We may assume that the playing software has been previously downloaded to the first terminal from the same server, so that the first terminal has stored the address together with the software itself. Even if the playing software had been brought to the first terminal through some other route like on an attachable memory module, the downloading address may have come together with the software. Steps 105 and 106 are again same as in FIG. 1. An important difference comes after step 106 where the second terminal has received the second user's acceptance for playing the game. Instead of contacting the first terminal, at step 207 the second terminal sends to the game server a request for downloading the playing software or the missing parts thereof. As a response the game server transmits at step 208 the requested information. After having received the requested information, the second terminal transmits at step 109 an acknowledgement message to the first terminal, indicating that it is now ready for playing. This step, as well as the indication steps 110 and 111 and the playing step 112 are the same as in the embodiment of FIG. 1.

The communication connection between the second terminal and the game server at steps 207 and 208 may physically take the form of a data call, a packet-switched communication connection, a WAP connection (Wireless Application Protocol), an SMS connection or any other connection. In order not to unnecessarily delay the beginning of the game, the physical form of the connection is most advantageously selected to be as fast as possible.

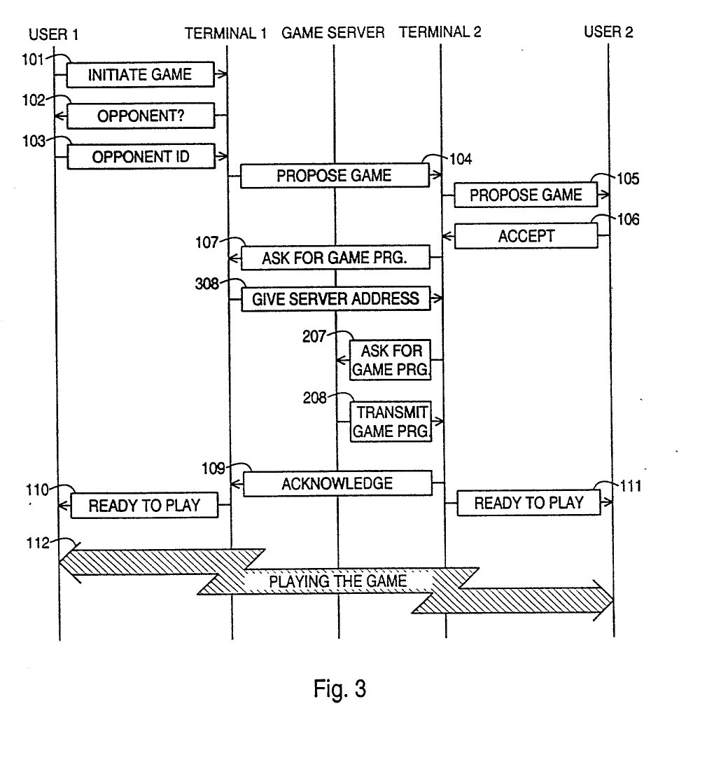

FIG. 3 illustrates the application of another embodiment of the invention which differs only slightly from that of FIG. 2. We call the embodiment of FIG. 3 the “If you want to play with me I tell you where to get the game” embodiment. Steps 101, 102, 103, 104, 105, 106 and 107 are actually the same as in the embodiment of FIG. 1. However, as a response to the second terminal's request for downloading the playing software or key component thereof at step 107, the first terminal does not directly provide the requested information but transmits, at step 308, the network address of the game server or other network resource from which the requested information can be downloaded. Thereafter the requesting and downloading operations between the second terminal and the game server at steps 207 and 208 take place as in the embodiment of FIG. 2. The remaining acknowledgement and indication steps 109, 110 and 111 and the playing step 112 are the same as in the embodiments of FIGS. 1 and 2.

Mirror images of the embodiments of FIGS. 2 and 3 are also encompassed by the invention; mirroring means that the second terminal is the one already possessing the playing software or key component thereof and the first terminal must acquire it. In FIG. 2 this means that the proposal of step 204 does not necessarily contain a server address, and that instead of asking for the playing software or key component thereof from the game server at step 207 the second terminal transmits to the first terminal a message where it agrees to play a game and tells the first terminal the server address. The steps of asking for and providing the playing software or key component thereof according to steps 207 and 208 take part between the first terminal and the game server, whereafter the first terminal transmits the acknowledgement of step 109 to the second terminal and not vice versa as in FIG. 2. Mirroring the embodiment of FIG. 3 means that at step 107 the second terminal agrees to play, after which at step 308 the first terminal asks for the server address. Thereafter comes an additional step in which the second terminal transmits to the first terminal a message where it tells the first terminal the server address. Thereafter the procedure continues as in the above-explained mirror image of FIG. 2 from the steps of asking for and providing the playing software or key component thereof.

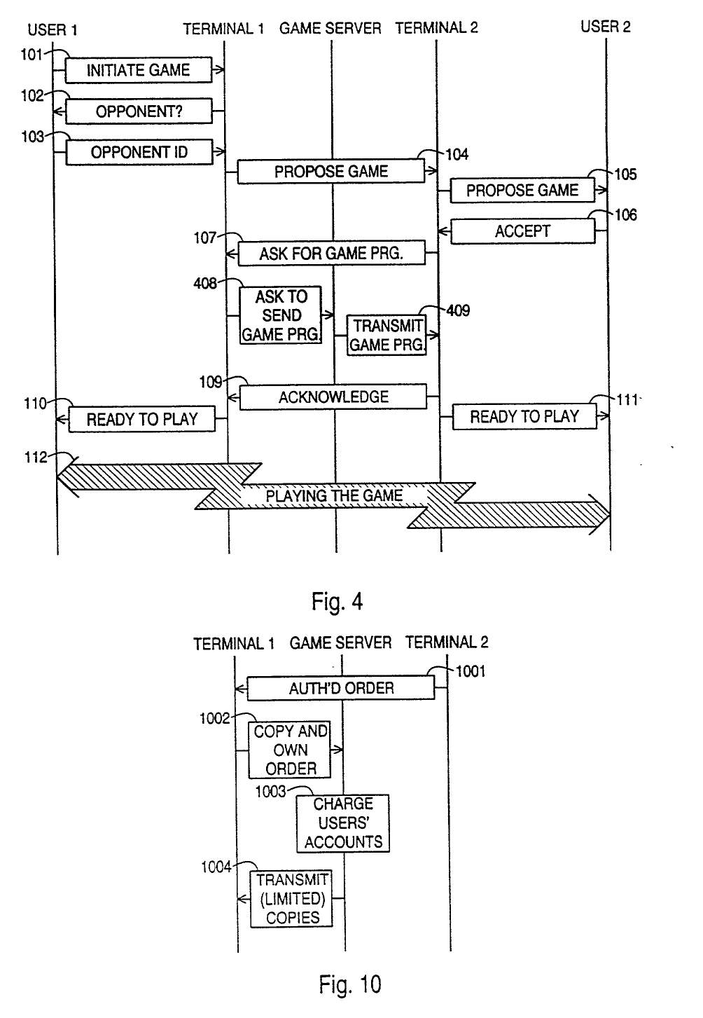

FIG. 4 illustrates the application of another embodiment of the invention which also differs only slightly from that of FIG. 2. We call the embodiment of FIG. 4 the “If you want to play with me I ask them to send you the game” embodiment. Steps 101, 102, 103, 104, 105, 106 and 107 are again the same as in the embodiment of FIG. 1. However, as a response to the second terminal's request for downloading the playing software or key component thereof at step 107, the first terminal does not directly provide the requested information but transmits, at step 408, to the game server a request for downloading the playing software or the missing parts thereof also to the second terminal. This request must naturally comprise some kinf of identification information of the second terminal so that the game server is able to “attach the correct address label” to its transmission. As a response the game server transmits at step 409 the requested information to the second terminal, which acknowledges the successful reception of the transmitted information with an acknowledgement message to the first terminal at step 109. Steps 110, 111 and 112 are the same as before.

In a mirror image of the embodiment of FIG. 4 step 107 is omitted and steps 408, 409 and 109 are flipped 180 degrees about the “GAME SERVER” line. In other words, the second terminal asks the game server to send the playing software or the missing parts thereof to the first terminal, such transmission is accomplished and the first terminal acknowledges to the second terminal having received the transmission.

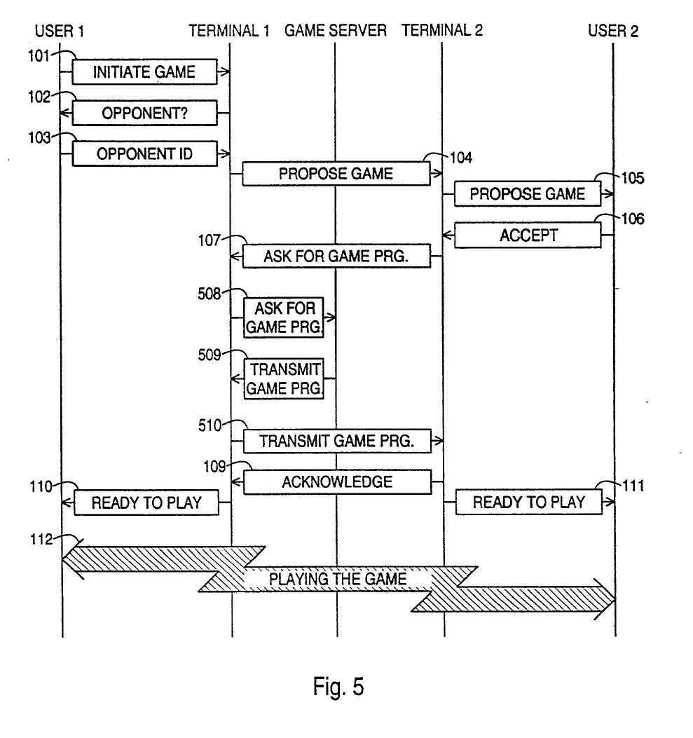

A characteristic feature of the embodiments described so far, except the mirror image embodiments, is that the first terminal is assumed to possess a fully operational version of the playing software even before proposing a playing session to the second terminal. The invention does not require such an assumption to hold. FIG. 5 illustrates an “Let's play, I'll get the game” embodiment of the invention where the steps 101, 102, 103, 104, 105, 106 and 107 are again the same as in the embodiment of FIG. 1. However, as a response to the second terminal's request for downloading the playing software or key component thereof at step 107, the first terminal does not directly provide the requested information but transmits, at step 508, to the game server a request for downloading the playing software or the missing parts thereof to the first terminal. As a response the game server transmits at step 509 the requested information to the first terminal. After having received the requested information, the first terminal forwards it at step 510 to the second terminal, which acknowledges the successful reception of the transmitted information with an acknowledgement message to the first terminal at step 109. Steps 110, 111 and 112 are again the same as before.

In a mirror image of FIG. 5 step 107 is omitted, steps 508 and 509 take place between the second terminal and the game server, at step 510 the second server transmits some version of the playing software or the missing parts thereof to the first terminal and at step 109 the first terminal acknowledges. In another slightly altered embodiment the second terminal already possesses the playing software or the missing parts thereof but the first terminal does not. In such a case the contents of the message at step 107 would be “OK, I have it already, you go and get one yourself”. In that case the message at step 510 would be an acknowledgement where the first terminal announces it to be ready, after which steps 110 and 111 can be executed without another acknowledgement at step 109.

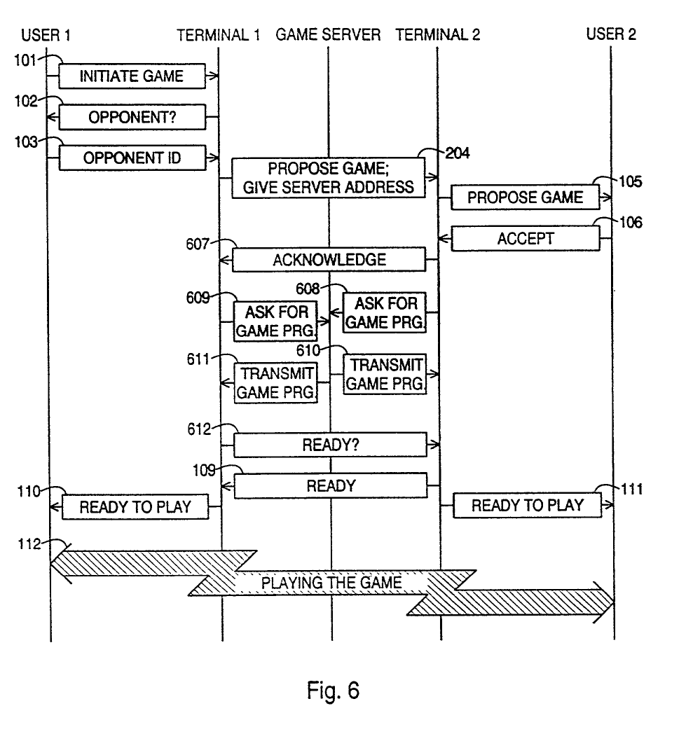

FIG. 6 illustrates the application of an embodiment of the invention which is a kind of combination of the embodiments of FIGS. 4 and 5. The designation of this embodiment is “Let's get a game and play it”. Steps 101, 102, 103, 105 and 106 are the same as in e.g. FIG. 1, and step 204 is the same as in FIG. 2 in the sense that the proposal of the first terminal also includes the network address from which the playing software can be downloaded. Step 607 which takes place after step 106 is an acknowledgement from the second terminal where it announces to the first terminal the second user's willingness to play. After that both terminals send to the game server their own requests for downloading the playing software or the missing parts thereof at steps 608 and 609. The game server responds by transmitting the requested information to both terminals at steps 610 and 611. After having successfully received the requested information, one of the terminals, which in FIG. 6 is the first terminal but which could as well be the second terminal, transmits at step 612 to the other terminal a message where it announces itself to be ready and may even ask the other terminal about its readiness. At the next step the other terminal confirms that it also is ready; this message is actually an acknowledgement just like that previously introduced as step 109, so the same reference designator is used also in FIG. 6. Steps 110, 111 and 112 are again the same as before.

The idea of FIG. 6 can be implemented with one transmitted message less if, instead of sending the first acknowledgement 607, the second terminal executes steps 608 and 610 immediately after receiving the accept command 106 from the user and only thereafter sends an acknowledgement like that of step 607 to the first terminal. The first terminal would then execute steps 609 and 611 after receiving said acknowledgement and transmit a general ready message 612 after it had downloaded the playing software or the missing parts thereof. Step 109 could then be omitted, and steps 110 and 111 would come immediately after step 612. However, this alternative doubles the waiting time before playing may begin since the downloadings take place in succession rather than simultaneously as in FIG. 6.

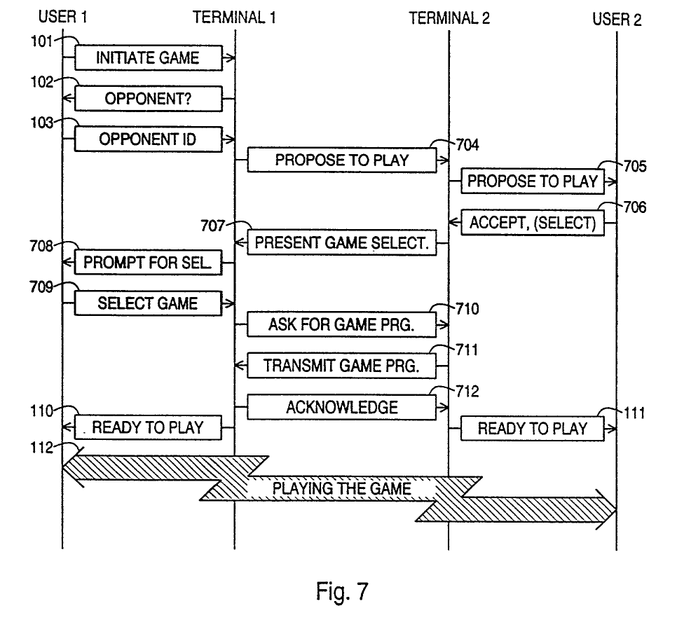

The embodiments described so far have underlined the role of the first user in selecting the game to be played. FIG. 7 illustrates the application of another embodiment of the invention where the second user has much more to say in this respect. This embodiment is designated as the “Let's play one of your games” embodiment. Steps 101, 102 and 103 are the same as before. However, the proposal sent by the first terminal to the second terminal at step 704 is only a general proposal for playing a game together. It may contain some limiting information describing the preferences of the first user and/or the capability of the first terminal, like “Let's play some game which is suitable for children under 10 years”, “Let's play some card game” or “Let's play some game which can be run in a terminal of type XX (or in a terminal of capability class YY)”. The invention does not obligatorily require it to contain any such limitations. At step 705 this proposal is conveyed to the second user. Before conveying the proposal to the second user the second terminal may translate any preferences contained therein into some other form, e.g. depending on the capability of the second terminal. As an example we may assume that the first terminal proposed at step 704 to play “a card game, chess, go or some variation of the worm game”. We further assume that of these, only card and worm games can be run in the second terminal, in which case the second terminal conveys at step 705 to the second user a proposal in the form “Opponent NN would like to play some card game or some variation of the worm game against you”.

At this stage the second user could again turn down the whole proposal. However, we assume that the second user expresses at step 706 his willingness to play. Additionally the second user may already at this stage select the game he wants to play, or select a subset of the proposed set of games. We further assume that in the case of FIG. 7 the second user would be willing to play some card game, but he lets the first user to select which one. In that case the acceptance input to the second terminal at step 706 has the form “OK, some card game against NN would be nice”. If the second user would accept any of the proposed games, he would simply express his agreement at step 706. As a response, the second terminal transmits at step 707 to the first terminal a message in which it presents the selection of games the software of which exists in stored form in or at the disposal of the second terminal. If the second user had made limitations at step 706, the transmission at step 707 would contain only the correspondingly limited selection of games. At step 708 the first terminal forwards the selection of games to the first user and prompts the first user to select the game to be played. At step 709 the first user makes his selection. As a response, the first terminal transmits at step 710 a request for the required software or the missing component to the second terminal. The form, contents and routing possibilities of the request correspond to those described in association of step 107 in FIG. 1. When the second terminal has received the request, it transmits the software or the missing component thereof to the first terminal at step 711.

If the second user would have wanted to decide exactly the game which he would like to be played, he could have simply made his selection at step 706. In such a case the selection of games presented to the first terminal at step 707 and further to the first user at step 708 would only consist of a single game. Step 709, which above is said to consist of the first user making his selection among a group of proposed games, would thereby become a simple accept/reject decision: either the first user accepts the game to be played or he turns down the proposal.

In any case, after the transmission of the playing software or the missing component thereof is complete and the first terminal has received and stored the appropriate pieces of information that make it capable of running the playing software, it sends at step 712 an acknowledgement message to the second terminal and announces to the first user at step 110 that playing may begin. The second terminal gives a similar indication to the second user at step 111. Thereafter the actual playing of the game may start, as is generally represented in FIG. 7 as step 112.

The multitude of approaches in using a game server as the source of downloading the playing software or a key component thereof, presented above in association of FIGS. 2 to 6, can naturally also be applied to the principle of FIG. 7 where the second terminal is given at least partly the responsibility of deciding, which game(s) is/are to be played. As an example, at step 707 the second terminal may inform the first terminal about the network address(es) from which the games may be downloaded, which corresponds to the principle of FIG. 2, or the network address might be given only after the first terminal's request at step 710 similarly as in FIG. 3.

In association with FIGS. 1 to 6 we discussed mainly those cases where the first user proposes a certain individual game to the second user. A generalisation is possible in this respect: at all those steps where the first terminal is said to transmit to the second terminal a proposal for the game, the first terminal may actually transmit a whole list of games. When the second terminal proposes the games in the list to the first user, it may again limit the selection to those games which are possible to run in the second terminal. In stating his acceptance the second player selects the game he agrees to play, and the step of asking for the game program is amended so that the second terminal announces exactly which one of the proposed games should be downloaded.

Next we will examine the procedures illustrated in FIGS. 1 to 7 from the viewpoint of the “content” assumption mentioned previously. It is typical to the “content” assumption that after the distribution of the recreational application has been accomplished, there is little or no such interaction between the terminals that would directly relate to consuming the recreational application. Each user of a terminal consumes his obtained copy of the recreational application by himself, like by listening to a piece of music or by reading an article. However, in order to keep dishonest users from making and distributing illegal copies of copyright-protected material, it may be required that during the time of consuming the recreational application the terminals must be close enough to each other so that they can exchange control messages through a short-distance communications connection. Alternatively or additionally a copy of distributed “content” (or certain important piece of software that is needed for its consumption) may be equipped with a time bomb type algorithm that only allows it to be consumed for a limited time after distribution.

Under the “content” assumption we may explain step 101 in FIG. 1 so that the user of the first terminal initiates the lending of some content to another user. At step 102 the first terminal prompts the user to identify the party to which the recreational application is to be lent, and at step 103 the first user gives some identification information of the second user. At step 104 the first terminal sends a message to the second terminal, the essential contents of the message being a proposal to receive a copy of the recreational application in question. At step 105 the second terminal presents the proposal to its user (known as the second user) through a user interface, and at step 106 the second user expresses his acceptance. At step 107 the second terminal asks the first terminal to transmit the recreational application in question, and the actual transmission of the recreational application follows at step 108 with an acknowledgement from the second terminal to the first at step 109. Due to the limited amount of following interaction between userd the “ready to consume” messages are now not needed, so step 110 may be completely omitted and step 111 may consist of simply beginning the consumption, i.e. starting the presentation of the acquired copy of the recreational application to the second user.

Following the assumption that communication through a short-distance communications connection must be active during the time when the second user is allowed to consume the recreational application, we may say that step 112 in FIG. 1 illustrates such communication. We may denote such communication as “patting the watchdog”. The invention does not place limitations to the actual way that is used for patting the watchdog. The short-distance communications connection used is typically a short-distance wireless link such as a Bluetooth connection or an infrared connection. In order to make the patting routine safe against attempts of recording the actions of the first terminal and using some sort of reproduction device to imitate them after the first terminal has gone, the patting routine should involve certain dynamic nature, i.e. the signals used for patting should change over time. We regard the actual implementation of suitable patting routines as falling within the capability of a person skilled in the art. Also the invention does not place limitations to whether the consumption of same content should be disabled or not at the first terminal during the time when the content is consumed at the second terminal. Both alternatives are possible.

The procedure of FIG. 2 is easily understood also under the “content” assumption. Steps 101 to 106 are the same as above, and at step 207 the second terminal contacts a content server instead of the first terminal to ask for downloading the content in question. Downloading the requested content from the content server to the second terminal takes place at step 208, after which an acknowledgment is sent to the first terminal at step 109 in order to start the patting the watchdog routine. Step 110 can be again omitted (although here as well as above it may be useful to inform the first user about the latest developments in successfully acquiring a copy of the content in question by the second terminal), and steps 111 and 112 are the same as above.

The procedures illustrated in FIGS. 3 to 7 are likewise easily read under the “content” assumption by noting that in each downloading step the content in question (or a certain important software component needed to consume the content in question) is downloaded and not a game. The patting the watchdog routine applies in a similar way in all cases.

We will now move on to the subject of defining the rights of using the playing (or more generally: recreational) application and the possibilities for charging at least one of the users a fee for the playing or consuming session which is set up according to one of the embodiments described above. With respect to the rights, we assume that there exist at least two categories of licences: a copy of the recreational application may come either as fully licenced, in which case it can be freely used for any playing or consuming session either alone or against/with one or more opponents, or it may come with a restricted licence which allows its use only during a certain session and/or against a certain opponent or group of opponents. Known arrangements exist for automatically enforcing such licencing conditions: for example a copy of software with a limited licence may be only run through for a limited number of times, in which case a counter built into the software itself disables further attempts of use after the maximum count has been reached. Or the software may only operate correctly after it has checked that the time obtained from some real time clock is within predetermined limits. In other arrangements all outgoing messages are encrypted with a key which or the counterpart of which is only known to a certain registered opponent. The actual mechanism which is used to implement a restricted licence are not important to the present invention: it suffices to know that such a mechanism exists.

In the embodiment of FIG. 1 it is most natural to assume that the first terminal possesses a fully licenced copy of the recreational application, or at least such a copy where the choice of opponent(s) is not limited, because otherwise the step of choosing the opponent would not make sense. It is also natural to assume that the first user has paid a fee at the stage when he acquired the recreational application and stored it into his terminal. In order not to allow the second user to take undeserved advantage of the fact that he actually gets a copy of the recreational application which only the first user paid for, it is advisable to transmit at step 108 only a copy of the recreational application with a limited licence. The limitation may be temporal so that the second user can only use the software for a certain time, or related to the number of sessions so that the second user may only use it once or only a few times (preferably in his session against the first user), or even personal so that the second user may only use the software to play against the first user, which is the legal owner of the software copy. It may be advantageous place even a limitation which disables any solitary use of the software in the second terminal alone. Above we have already described the possibility of placing a restriction depending on physical location or more accurately on mutual distance of two terminals.

The embodiments of FIGS. 2 and 3 have the common feature that the second terminal requests and downloads its own copy of the recreational application directly from the game or content server, which we assume to be run if not directly by the original owner of rights then at least with his consent. Therefore it is rather straightforward to arrange the downloading of such a copy of the recreational application the licenced rights of which correspond to the needs of the second user, and also for charging the appropriate fee (if any) from the second user. This applies especially if the recreational application copy to be downloaded is not meant to be associated with the fact that it was actually a certain first user which originally proposed playing the game or consuming the content. However, we may envisage also a situation where the first user offers to pay to the owner of rights the fee which is payable for the intended playing or consuming session. In such a case certain cryptographic authentication methods may be used in accordance with FIG. 8. At step 801, which typically coincides with the general step 104 or 204 of proposing for a game or a session, the first terminal transmits to the second terminal a cryptographically authenticated offer where the first terminal offers to pay for a session with the second terminal. Known cryptographical autenhication methods exist for providing both authentication of origin and non-repudiation, i.e. for ensuring that even if such an offer is later used somewhere else it is clear that the originator was just the first terminal in question and the first terminal can not even deny having sent such an offer. Additionally it is clear even later that it was just the second terminal in question against which the first terminal intended to play, and not any arbitrary second terminal.

The extent to which the second user should be able to use the recreational application can be chosen by the first user and encoded into the cryptographically authenticated offer. Naturally the first user may even offer to pay for a complete, fully licenced copy to the second user. However, we expect that a more often encountered situation is such where the first user offers to stand for the costs of a single session only or for a limited number of sessions between him and the second user.

At step 802, which typically coincides with the request step 207, the second terminal presents said cryptographically authenticated offer to the game or content server. From the offer the game server checks, who is the party who offered to pay the fee, and whether the second terminal that presented the offer is just the second terminal which is mentioned in the offer as the intended opponent. The latter check is used to ensure that the user presenting the offer is not any third party which would have snatched the offer from the Internet or other unsecure communication network. At step 803 the game or content server deducts the fee for one (usually limited) licence from the account of the first user, and at 804 which typically coincides with step 208 the game or content server transmits the recreational application with its associated (limited) licence to the second terminal.

The arrangement of FIG. 4, where the first terminal instructs the game or content server to transmit a recreational application to the second user, readily suggests that also here it would be the first user who stood for the costs. When the order for the recreational application to the second terminal comes directly from the first terminal to the game or content server, it is even simpler than in the above-described arrangement of FIG. 8 to enable the first terminal to define the licence conditions for the copy to be transmitted to the second terminal: the first terminal simply transmits at step 408 to the game or content server a cryptographically authenticated message in which it instructs the game or content server to send to the second terminal a recreational application with the licence as defined in the message itself, and to charge the associated fee (if any) from the account of the first user. However, the embodiment of FIG. 4 also allows for the authenticated order to come from the second terminal in accordance with FIG. 9. At step 901, which typically coincides with step 107, the second terminal transmits to the first terminal a cryptographically authenticated order in which the second terminal defines the licencing conditions which it wants to apply to its ordered copy of the recreational application. At step 902, which typically coincides with step 408, the first terminal forwards the cryptographically authenticated order to the game or content server. At step 903 the server decodes the order. If an intended opponent (the first terminal) is mentioned in the order, the game or content server may even check at step 903 that the order came through the mentioned intended opponent. The server deducts the appropriate fee (if any) from the account of the second user and transmits, at step 904 which is the same as step 409 in FIG. 4, the ordered recreational application to the second terminal.

Any of the approaches of FIGS. 8 and 9, or both, may be used in association with the embodiment of FIG. 5. If the first user stands for the costs, the corresponding cryptographically authenticated order is transmitted to the game or content server together with the request of step 508. If the second user wants to pay, the corresponding cryptographically authenticated order is transmitted to the first terminal at step 107 and forwarded to the game or content server together with the request of step 508. FIG. 10 illustrates a combined approach where at step 1001, which typically coincides with step 107, the second terminal transmits to the first terminal a cryptographically authenticated order in which the second terminal defines the licencing conditions which it wants to apply to its own ordered copy of the recreational application. At step 1002, which typically coincides with step 508, the first terminal forwards the cryptographically authenticated order to the game or content server along with its own cryptographically authenticated order in which the first terminal defines the licencing conditions which it wants to apply to its own ordered copy of the recreational application. At step 1003 the server decodes the orders. If an intended opponent is mentioned in the orders, the game or content server may even check at step 1003 that the orders constitute a matching pair. The server deducts the appropriate fees (if any) from the accounts of the users and transmits, at step 1004 which is the same as step 509 in FIG. 5, the ordered recreational application copies to the first terminal. It is then on the responsibility of the first terminal to forward the correct copy to the second terminal.

Any of the approaches described above in association with FIGS. 8, 9 and 10 can be applied in association with the embodiment of FIG. 6. The embodiment of FIG. 7 is a kind of mirror image of that of FIG. 1 in the sense of distributing the recreational application copies under certain licence conditions. It is on the responsibility of the second terminal to transmit, at step 711, a copy with a suitably limited licence to the first terminal so that the user of the first terminal does not get any undeserved advantage e.g. in the form of a recreational application which he would not have paid for but which could be used freely.

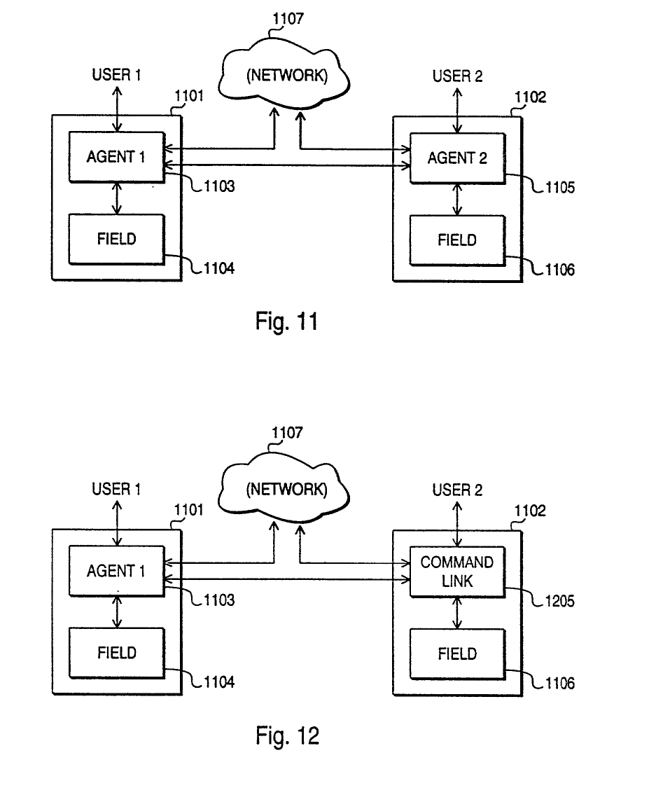

Next we will describe an advantageous general structure for the playing software and the aspects rising therefrom that relate to the distribution of the software and its components. FIG. 11 is a high-level block diagram which illustrates a first terminal 1101 and a second terminal 1102. In each terminal there are two software components that together constitute a certain piece of recreational software. In the first terminal 1101 there is the first agent program 1103 and a first copy of the field of activity 1104. Correspondingly in the second terminal 1102 there is the second agent program 1105 and a second copy of the field of activity 1106. The agent is an “active” component of the recreational software, whereas the field of activity is a “passive” component. These concepts have been defined so that the field is merely a certain allocated storage area where the momentary conditions and possible mutual relations of the elements of the recreational software are stored, whereas the agent is a collection of processes that interact with the user, the field, the opponent and possibly also with one or more elements in a network 1107.

Recalling our virtual board game example we may say that the field consists of the game board and the pieces, whereas the agent consist of all those processes that are related to maintaining and changing the locations and mutual relations of the pieces on the board. Typically the communication between playing parties is implemented as exchange of messages between the agents. The first and second copies 1104 and 1106 of the field of activity should remain synchronized in the sense that both players see the situation in the game to be the same. This does not mean that both players should receive exactly the same information about the situation in the game: for example in the majority of card games no one is allowed to see the hands of (i.e. the cards possessed and not shown by) the other players.

FIG. 12 illustrates an alternative high-level block diagram which is especially applicable to those situations where only a limited copy of the recreational software is given to one of the users. In the embodiment of FIG. 12 the users, the terminals 1101 and 1102, the first agent 1103, the first and second copies 1104 and 1106 of the field of activity and the network 1107 have similar roles as in FIG. 11. Instead of an agent of his own, the second user has only a command link program 1205 stored into his terminal. The difference between an agent and a command link is in capability: the message link 1205 is only capable of translating the commands given by the second user into changes within the second copy 1106 of the field of activity, conveying the commands to the first terminal, and receiving commands from the first terminal and translating them into changes within the second copy 1106 of the field of activity. We may say that the combination of a command link and a copy of the field of activity together constitute the minimum requirements of playing against another user which has an actual agent at his disposal. Below we will analyse certain potential advanced functional features of the agent; if the second user should be given any access to these in the arrangement of FIG. 12, they must be made available remotely so that the agent 1103 in the first terminal serves also up to some extent the second user.

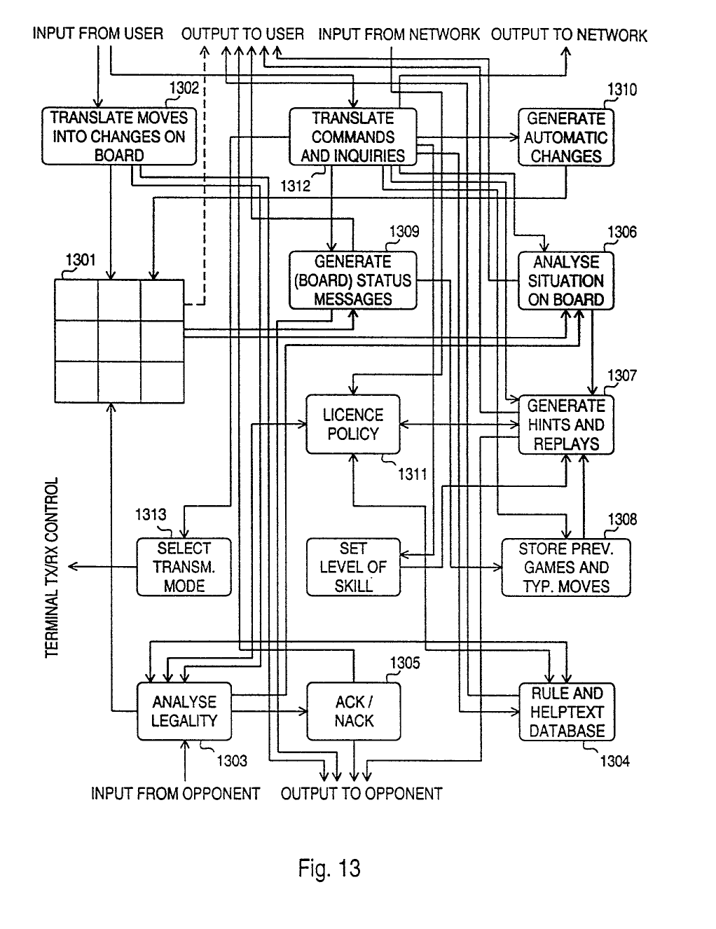

FIG. 13 illustrates a more detailed structure for an agent according to an embodiment of the invention. Also the field of activity 1301 is seen in FIG. 13. For the reason of illustrativeness we will use the language relating to board games in the following description, so e.g. the field of activity 1301 is called the board. A certain command interpreter block 1302 receives the move commands from the user (which move commands themselves may come in any form, like key presses, rollerbar movements, other mechanical movements, voice commands etc.) and translates them into a form where they represent directly certain movements of pieces on the board. The translated commands could be taken directly to the board 1302 to implement the changes, but in the embodiment of FIG. 13 we assume that they are first taken to an analysing block 1303 the task of which is to check, with the help of a set of rules read from a database 1304, that the moves are legal. Accepted moves can then be implemented on the board 1301. If a move is not accepted, a negative acknowledgement (NACK) can be generated for the user in block 1305.

In addition to analysing legality, the agent may also check, whether the intended move is wise and in accordance with a previously selected playing strategy. For this purpose the analysing block 1303 may forward a formally accepted move into another analysing block 1306 the task of which is to analyse the situation on the board 1301, and further to an electronic assistant block 1307 which generates, on the basis of the analysis given by block 1306, an evaluation of the intended move and gives it as an output to the user. In its evaluation work the electronic assistant block 1307 may consult a database 1308 of stored previous games and typical moves. Said database and the electronic assistant block 1307 may have been programmed to adapt their operation according to a certain identified opponent player, so that e.g. previous games against the same opponent are used in predicting, what would be the typical reaction of the opponent to a certain intended move. After having received the hint from block 1307, the user either makes another move or confirms the previous move so that the effect becomes visible on the board.

The moves made by the player could be transmitted as outputs to the opponent directly from block 1302. However, if it is the intention of the user to first let his agent to analyse his intended move and reveal to the opponent only those moves which actually become confirmed, it is possible to make the information to the opponent be generated in block 1309, which gives the status on the field after the move has been accomplished. Information from block 1309 comes also to the user himself and goes into block 1308 to be stored as a part of the game history.

Previously we noted that certain moves on the board may even take place automatically. Block 1310 is responsible for accomplishing these moves. They come into the knowledge of the user and the opponent through the status reports generated in block 1309.

Move commands from the opponent are first received in block 1303, where their legality is checked. If a move command from an opponent is found to be against the rules, a negative acknowledgement is transmitted to the opponent from block 1305. A simpler alternative would be just to ignore move commands that are against the rules. If the approach of using acknowledgements is chosen, it is advantageous to make block 1305 to transmit an acknowledgement, positive this time, even for accepted moves so that the opponent knows that his move command has come through. Block 1303 may even check from a licence policy block 1311 that it is allowable, under the existing licence conditions, to accept commands from (i.e. to play against) a certain opponent. Accepted move commands from the opponent take effect on the board 1301. If the agent is used remotely also by the opponent as in FIG. 12, the above-described loop of analysing and possibly suggesting a better move through the actions of blocks 1303, 1306, 1307 and 1308 can also be used. Before giving hints to the opponent, block 1307 may check from the licence policy block 1311 that it is allowable, under the existing licence conditions, to give assistance to a certain opponent.

The user may give also other kind of inputs to the agent than just move commands. In the arrangement of FIG. 13 these are interpreted in a command and inquiry interpreter block 1312. For example, a command to use a local communication link instead of the general network interface for communication with another terminal is routed from block 1312 to a transmission mode selection block 1313 and furher to the transmission mode selection unit of the terminal (not shown). The user may also request status information of the current situation on the board as well as other aspects relating to the game: such requests are routed from block 1312 to block 1309. Through block 1312 the user may also control the generation of automatic moves in block 1310. If the concept “automatic moves” is understood widely, it covers also the arrangements related to the beginning of a game where the pieces are set into their starting positions. The user may give commands related to the storing of previous games and moves typical to certain strategies, to the generation of hints and replayes of previous games and moves, and to the analysing of the situation on the board. These commands are routed from block 1312 to blocks 1308, 1307 and 1306 respectively. A request for a rule or a help text is routed from block 1312 to block 1304, which provides the requested information to the user, possibly after checking from the licence policy block 1311 that it is allowed, under the current licence conditions, to provide the user with output copies of rules and/or help texts.

The user may also select the skill which he wishes the hints given by block 1307 to represent, or to switch off the advisory function of block 1307 completely. Such requests are routed from block 1312 to a skill level definition block 1314 which controls the operation of block 1307. There may also be couplings from the agent to a telecommunications network; in FIG. 13 these are represented by a connection from the network into the licence policy block 1311 and from block 1312 to the network. The network connection can be used e.g. for checking and updating licence policies and for transmitting downloading requests to a game server in the network.

It is not necessary to use the agent between the field and the user just to show the status of the field. The display driver of the terminal may have the right to directly access the memory location where the representation of the field and its current situation is stored so that the information is transferred directly from the storage location through the display driver into the display and further visually to the user. This connection is shown in FIG. 13 with a broken line.

Taken that the agent has multiple roles and functions as was described above in association with FIG. 13, it is easy to present simpler and more complicated versions of agents so that in a simpler version only a part of the functions of the more complicated version are available. Especially in a situation where only one of the players has acquired and paid for a fully licenced version of the software, it is advantageous to keep a fully functional agent program only at the disposal of that player and distribute simpler agent versions to the other players participating in a playing session. This way one would ensure that the other players can not take full advantage of the distributed software components afterwards, without paying the fee for a complete version downloaded from the game server. A simpler version need not be physically a real subpart of the more complicated version; it suffices to lock some of the components shown in FIG. 13 behind a password which a user can only obtain from an authorized dealer of the software.

Naturally both players can also have equally equipped and equally helpful agents at their disposal to help them in executing the recreational application. Yet another alternative is such where the initiating player (who has typically acquired and paid for a fully licenced version of the software, and who is thus most likely to be the most experienced one of the players in this particular software), lends a more helpful agent to his inexperienced opponent than what he is using himself. The experienced player may play even completely without help from any artificial intelligence, while the inexperienced player (or the players together) may select a suitable level of assistance from the agent to help the inexperienced player to be a more equal opponent. Getting a chance of winning as well as getting the impression of playing against an opponent whose level of skill is suitably high to offer some challenge, be it with the help of artificial intelligence or not, motivates each player to continue playing more and more.

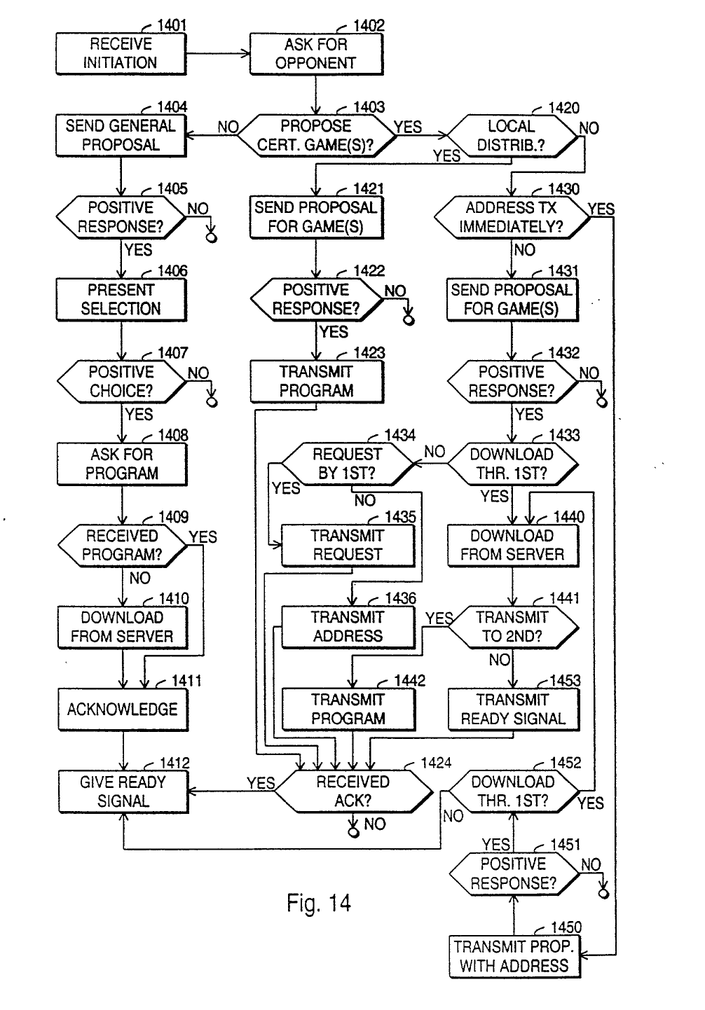

FIG. 14 illustrates a method according to an embodiment of the invention, especially the method executed by a terminal which acts as the first terminal in a situation of one of FIGS. 1 to 7. The operation begins at step 1401 when the terminal receives from its user an initiation for playing a game which requires an opponent. At step 1402 the terminal asks the user to identify the opponent and receives some identification of the opponent. Step 1403 is a decision between proposing a certain game or games (embodiments of FIGS. 1 to 6) and just proposing to play (embodiment of FIG. 7). A negative decision at step 1403 leads to step 1404 where just a general proposal is sent to the opponent. At step 1405 the terminal waits for a positive response from the second terminal; if such a response does not arrive in a reasonable time, the procedure terminates which in FIG. 14 is illustrated by a small circle. A positive response from the second terminal at step 1405 means that the second terminal presents a selection of games. This selection is forwarded to the user at step 1406. At step 1407 the terminal waits for the user to make his choice. No choice or a negative answer again lead to termination of the procedure.

When the user has made his selection, the terminal asks at step 1408 the second terminal to transmit the required software or the missing part thereof. Step 1409 is a check whether the software or the missing part thereof was received locally. A negative finding means that only a network address was obtained, in which case the software or the missing part thereof is downloaded from the game server at step 1410. When the software or the missing part thereof has been obtained in one way or another, an acknowledgement is transmitted to the second terminal at step 1411. After the terminal has given a “ready” signal to the user at step 1412 playing may begin.

If a positive decision was made at step 1403, the terminal is acting as in one of FIGS. 1 to 6. At step 1420 it checks, whether the software or the missing part thereof should be distributed locally or whether the game server will be involved. A positive finding at step 1420 leads to a procedure according to FIG. 1 beginning with step 1421 where the terminal transmits a proposal for a certin game or a selection of games to the second terminal. Steo 1422 denotes waiting for a positive response from the second terminal. If none is obtained, the procedure terminates. If the second terminal gives a positive response, possibly identifying a game if a list of games was proposed, the software or the missing part thereof which was requested is transmitted at step 1423. At step 1424 the terminal waits for an acknowledgement; if it remains missing, the procedure terminates. After a positive acknowledgement at step 1424 the terminal gives a “ready” signal to the user at step 1412 and the playing may begin.

After a negative decision at step 1420 the terminal decides at step 1430 whether it should send the network address of the game server to the second terminal immediately in the proposal, like in FIGS. 2 and 6. A negative decision at step 1430 means that just a proposal for game or games is transmitted to the second terminal at step 1431, like in FIGS. 3, 4 and 5. Again a positive response is waited for at step 1432 with the possibility of terminating procedure if the positive response does not come. When it comes it causes a transition to step 1433 where the first terminal checks whether it should itself download the software or the missing part thereof. A negative decision at step 1433 means that the procedure of either FIG. 3 or FIG. 4 is followed. Step 1434 is a further check whether the first terminal should request the game server to serve the second terminal. A positive finding at step 1434 means that the procedure of FIG. 4 is followed, in which case the first terminal transmits the request to the game server at step 1435. A negative finding at step 1434 means that the procedure of FIG. 3 is followed, in which case the first terminal only transmits the network address of the game server to the second terminal at step 1436. In either case the first terminal ends up at step 1424 waiting for an acknowledgement; if it remains missing, the procedure terminates. After a positive acknowledgement at step 1424 the terminal gives a “ready” signal to the user at step 1412 and the playing may begin.

A positive finding at step 1433 means that the first terminal must itself download the software or the missing part thereof, as in FIG. 5, which it does at step 1440. If the procedure of FIG. 5 is followed, a positive decision is always made at step 1441 meaning that the software or the missing part thereof is transmitted to the second terminal at step 1442. The first terminal ends up again at step 1424 waiting for an acknowledgement; the above-given description applies from there on.

A positive finding at step 1430 meant that the procedure of either FIG. 2 or FIG. 6 is followed. The proposal with the network address(es) of the game server(s) is transmitted at step 1450. After a check for a positive response at step 1451 there is a check at step 1452 whether the procedure of FIG. 2 or FIG. 6 is followed: a negative finding means a direct transition to step 1412, because the positive response received already counted as an acknowledgement (see step 109 in FIG. 2), and a positive finding at step 1452 means a transition to the downloading step 1440, after which the first terminal now arrives at a negative decision at step 1441, transmits its own ready signal to the second terminal at step 1453 and goes into step 1424 waiting for an acknowledgement; the above-given description applies from there on.

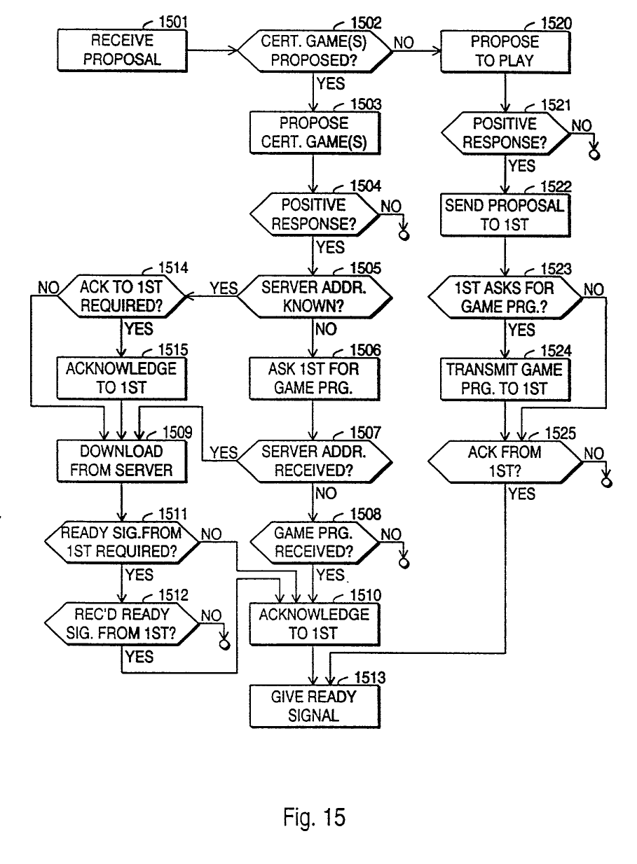

FIG. 15 illustrates a method according to another embodiment of the invention, especially the method executed by a terminal which acts as the second terminal in a situation of one of FIGS. 1 to 7. The operation begins at step 1501 when the terminal receives from the first terminal a proposal for playing a game. Step 1502 is a check whether the opponent is proposing a certain game or games (embodiments of FIGS. 1 to 6) or just proposing to play (embodiment of FIG. 7). A positive finding at step 1502 leads to step 1503 where the proposal identifying the game(s) is presented to the user. At step 1504 the terminal waits for a positive response from the user; if such a response is not given in a reasonable time, the procedure terminates which in FIG. 15 is illustrated by a small circle. A positive response from the user at step 1504 means that the user agrees to play the proposed game or one of the proposed selection of games.

When the user has made his selection, the terminal checks at step 1505 whether it already knows a network address from which the required software or the missing part thereof should be downloaded. A negative finding means either that a network address is still to be obtained or that the software or the missing part thereof is to be received locally. In either case the terminal requests the first terminal to provide the software or the missing part thereof at step 1506. At steps 1507 and 1508 the terminal checks, what was received after such a request. Receiving a network address causes a transition to step 1509, where the software or the missing part thereof are downloaded from the game server. Receiving instead the software or the missing part thereof either directly from the first terminal or from the game server (the latter as a result of the first terminal having instructed the game server to transmit to the second terminal) leads to step 1510, where the reception is acknowledged to the first terminal. Receiving nothing leads to termination of procedure. From the downloading step 1509 the terminal may return to step 1510 without furher activity if it finds at step 1511 that it does not need to receive any further signals from the first terminal, or through steps 1511 and 1512 if first it is found at step 1511 that a ready signal is needed from the first terminal and subsequently such a signal is received at step 1512. In any case after step 1510 there comes step 1513 where a “ready” signal is given to the user, after which playing may begin.

A positive finding at step 1505 causes a transition to step 1514 where the terminal checks, whether an acknowledgement needs to be transmitted to the first terminal before downloading the software or the missing part thereof from the game server. If yes, transmission is accomplished at step 1515 before going into step 1509; if not, step 1515 is omitted.

A negative finding at step 1502 means that only a general proposal to play was received as in FIG. 7. In that case the proposal is conveyed to the user at step 1520. A positive response from the user at step 1521 identifies either a game or a group of games to be proposed to the first terminal at step 1522. If the first terminal asks for a software or the missing part thereof at step 1523, these are transmitted at step 1524. After the first terminal has acknowledged the transmission at step 1525, a “ready” signal is given to the user at step 1513, after which playing may begin.

The procedures illustrated in FIGS. 14 and 15 are easily understood also under the “content” assumption when one takes notice of the differences explained previously at the passage of the description where we described the compatibility of FIGS. 1 to 7 with said alternative assumption.

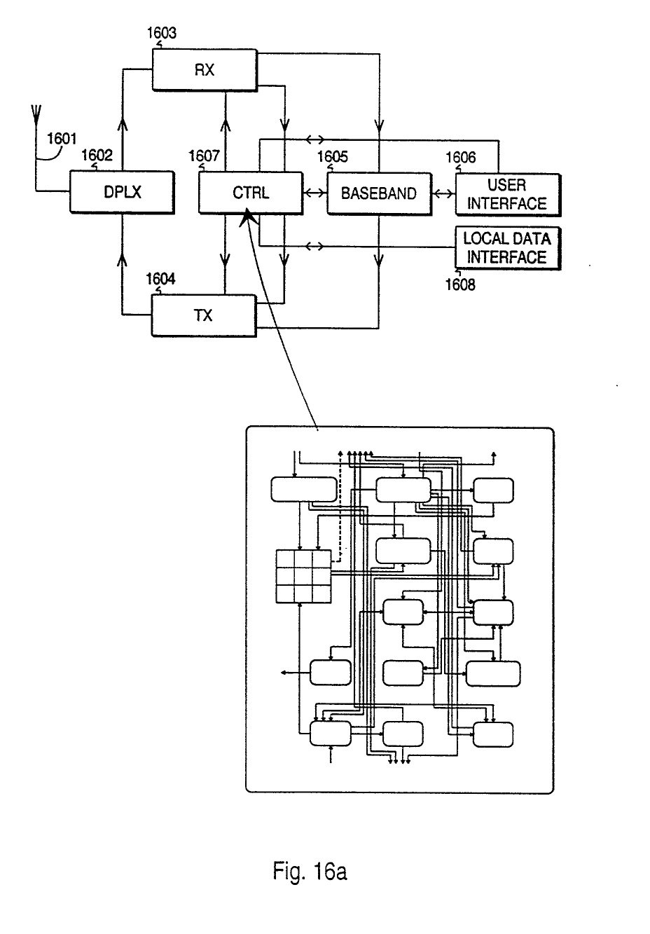

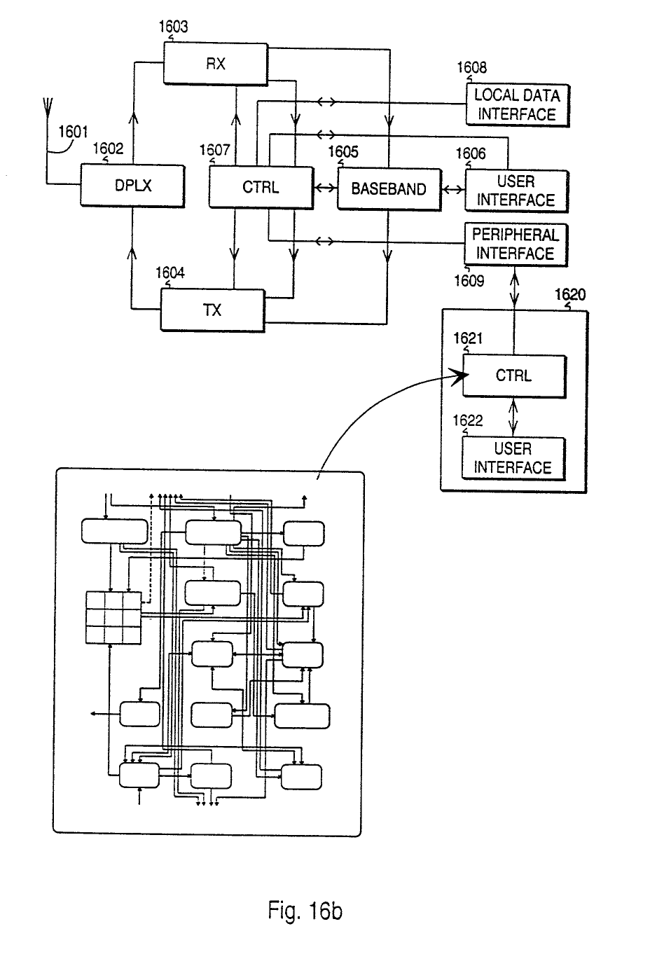

FIG. 16a illustrates schematically certain parts of a terminal arrangement according to an embodiment of the invention. In FIG. 16a the terminal arrangement consists simply of a terminal of a cellular radio system. An antenna 1601 is coupled through a duplexing block 1602 to a receiver block 1603 and a transmitter block 1604. The sink of payload data from the receiver block 1603 and the source of payload data to the transmitter block 1604 is a baseband block 1605 which in turn is coupled to a user interface block 1606 for communicating with a human or electronic user. A control block 1607 receives control information from the receiver block 1603 and transmits control information through the transmitter block 1604. Additionally the control block 1607 controls the operation of the blocks 1603, 1604 and 1605, and exchanges information locally through the user interface block 1606 and a local data interface block 1608. In accordance with the invention, the control block 1607 comprises the agent and field portions of the recreational software as was described in association with FIG. 13, or is at least programmed to execute at least one of the methods illustrated in FIGS. 1 to 7, 14 or 15 in order to get the agent and field portions of the recreational software stored.

FIG. 16b illustrates a terminal arrangement according to an embodiment of the invention where a terminal of a cellular radio system is locally coupled to a peripheral device 1620 which comprises its own control block 1621 and user interface 1622. In this case the the agent and field portions of the recreational software as was described in association with FIG. 13 are stored into the peripheral device 1620, and the control block 1607 of the cellular radio terminal is programmed to execute at least one of the methods illustrated in FIGS. 1 to 7, 14 or 15 in order to get the agent and field portions of the recreational software stored.

In the foregoing we have described mainly the application of the invention in a situation where exactly two users want to take part in a shared session of using a certain recreational application. The descriptions given above may be generalised into multi-user sessions with more the two users. The terminal of each user must take on the role of either the first or the second terminal as described above. In one typical multiuser embodiment of the invention the terminal of a certain one user acts as the first terminal, and the terminals of all other users act as second terminals. In this case the session begins when all those second terminals the users of which want to take part in the session have transmitted their acknowledgement messages to the first terminal. Another possibility is that the terminals challenge each other into the session in a chain so that of the first two terminals the terminal which first acted as a second terminal takes on the role of a first terminal in order to challenge a further terminal an so on, so that the acknowledgement that precedes the “ready” signals to users comes backwards in the chain of terminals and finally reaches the terminal which was the original first, initiating terminal.

The exemplary embodiments described above should not be construed to place limitations to the scope of protection which is defined in the appended claims. The word “comprise” is in this patent application meant to be an open limitation in the sense that stating that “A comprises B” does not exclude A from comprising also other parts than B.

1. A method for distributing a recreational application within a group of terminal arrangements, where the group comprises at least two terminal arrangements and each terminal arrangement comprises a terminal of a cellular radio system, the method comprising the steps of:
transmitting from a first terminal arrangement to a second terminal arrangement a proposal for setting up a session of utilising a recreational application and
only after the second terminal arrangement has received said proposal, using the communicational capabilities of at least one of the first and second terminal arrangements to establish a state where both the first terminal arrangement and the second terminal arrangement possess enough software components for setting up a common, shared session of utilising said recreational application.

2. A method according to claim 1, comprising the steps of:
a) transmitting from the first terminal arrangement to the second terminal arrangement a proposal identifying a number of proposed recreational applications,
b) transmitting from the second terminal arrangement to the first terminal arrangement a request for obtaining a software component necessary for setting up a common, shared session of utilising one of said proposed recreational applications and
c) as a response to receiving said request in said first terminal arrangement, transmitting said software component from the first terminal arrangement to the second terminal arrangement.

3. A method according to claim 2, comprising, between steps a) and b), the step of presenting said number of proposed recreational applications to the user of the second terminal arrangement, so that step b) is only executed as a response to receiving from said user an indication of acceptance concerning one of said number of proposed recreational applications.

4. A method according to claim 2, wherein step c) comprises the substep of transmitting said software component from the first terminal arrangement to the second terminal arrangement through a local communication link.

5. A method according to claim 2, wherein step c) comprises the substep of transmitting said software component from the first terminal arrangement to the second terminal arrangement through the cellular radio system.

6. A method according to claim 2, comprising after step c) the steps of:
d) transmitting from the second terminal arrangement to the first terminal arrangement an acknowledgement indicating the reception of said software component and
e) after step d), indicating to the users of the first and second terminal arrangements the readiness of utilising the recreational application.

7. A method according to claim 1, comprising the steps of:
a) transmitting from the first terminal arrangement to the second terminal arrangement a proposal identifying a number of proposed recreational applications,
b) transmitting from the second terminal arrangement to a recreational application server a request for obtaining a software component necessary for setting up a common, shared session of utilising one of said proposed recreational applications and
c) as a response to receiving said request in said recreational application server, transmitting said software component from said recreational application server to the second terminal arrangement.

8. A method according to claim 7, comprising between steps a) and b) the step of presenting said number of proposed recreational applications to the user of the second terminal arrangement, so that step b) is only executed as a response to receiving from said user an indication of acceptance concerning one of said number of proposed recreational applications.

9. A method according to claim 7, comprising after step c) the steps of:
d) transmitting from the second terminal arrangement to the first terminal arrangement an acknowledgement indicating the reception of said software component and
e) after step d), indicating to the users of the first and second terminal arrangements the readiness of utilising the recreational application.

10. A method according to claim 1, comprising the steps of:
a) transmitting from the first terminal arrangement to the second terminal arrangement a proposal identifying a number of proposed recreational applications,
b) transmitting from the second terminal arrangement to the first terminal arrangement a request for obtaining a software component necessary for setting up a common, shared session of utilising one of said proposed recreational applications,
c) as a response to receiving said request in said first terminal arrangement, transmitting a network address of a recreational application server from the first terminal arrangement to the second terminal arrangement,
d) transmitting from the second terminal arrangement to said recreational application server a request for obtaining a software component necessary for setting up a common, shared session of utilising one of said proposed recreational applications and
e) as a response to receiving said request in said recreational application server, transmitting said software component from said recreational application server to the second terminal arrangement.

11. A method according to claim 10, comprising between steps a) and b) the step of presenting said number of proposed recreational applications to the user of the second terminal arrangement, so that step b) is only executed as a response to receiving from said user an indication of acceptance concerning one of said number of proposed recreational applications.

12. A method according to claim 10, comprising after step e) the steps of:
f) transmitting from the second terminal arrangement to the first terminal arrangement an acknowledgement indicating the reception of said software component and
g) after step f), indicating to the users of the first and second terminal arrangements the readiness of utilising the recreational application.

13. A method according to claim 1, comprising the steps of:
a) transmitting from the first terminal arrangement to the second terminal arrangement a proposal identifying a number of proposed recreational applications,
b) transmitting from the second terminal arrangement to the first terminal arrangement a request for obtaining a software component necessary for setting up a common, shared session of utilising one of said proposed recreational applications,
c) as a response to receiving said request in said first terminal arrangement, transmitting from the first terminal arrangement to a recreational application server a request for downloading into the second terminal arrangement a software component necessary for setting up a common, shared session of utilising one of said proposed recreational applications and
d) as a response to receiving said request in said recreational application server, transmitting said software component from said recreational application server to the second terminal arrangement.

14. A method according to claim 13, comprising between steps a) and b) the step of presenting said number of proposed recreational applications to the user of the second terminal arrangement, so that step b) is only executed as a response to receiving from said user an indication of acceptance concerning one of said number of proposed recreational applications.

15. A method according to claim 13, comprising after step d) the steps of:
e) transmitting from the second terminal arrangement to the first terminal arrangement an acknowledgement indicating the reception of said software component and
f) after step e), indicating to the users of the first and second terminal arrangements the readiness of utilising the recreational application.

16. A method according to claim 1, comprising the steps of:
a) transmitting from the first terminal arrangement to the second terminal arrangement a proposal identifying a number of proposed recreational applications,
b) transmitting from the second terminal arrangement to the first terminal arrangement a request for obtaining a software component necessary for setting up a common, shared session of utilising one of said proposed recreational applications,
c) as a response to receiving said request in said first terminal arrangement, transmitting from the first terminal arrangement to a recreational application server a request for downloading into the first terminal arrangement a software component necessary for setting up a common, shared session of utilising said one of said proposed recreational applications,
d) as a response to receiving said request in said recreational application server, transmitting said software component from said recreational application server to the first terminal arrangement and
e) as a response to receiving said software component, transmitting from the first terminal arrangement to the second terminal arrangement a software component necessary for setting up a common, shared session of utilising said one of said proposed recreational applications.

17. A method according to claim 16, comprising between steps a) and b) the step of presenting said number of proposed recreational applications to the user of the second terminal arrangement, so that step b) is only executed as a response to receiving from said user an indication of acceptance concerning one of said number of proposed recreational applications.

18. A method according to claim 16, comprising after step e), the steps of:
f) transmitting from the second terminal arrangement to the first terminal arrangement an acknowledgement indicating the reception of said software component and
g) after step f), indicating to the users of the first and second terminal arrangements the readiness of utilising the recreational application.

19. A method according to claim 1, comprising the steps of:
a) transmitting from the first terminal arrangement to the second terminal arrangement a proposal identifying a number of proposed recreational applications,
b) transmitting from the second terminal arrangement to the first terminal arrangement a first acknowledgement indicating agreement to set up a common, shared session of utilising one of said proposed recreational applications,
c) transmitting from the first terminal arrangement to a recreational application server a first request for obtaining a software component necessary for setting up a common, shared session of utilising said one of said proposed recreational applications,
d) transmitting from the second terminal arrangement to a recreational application server a second request for obtaining a software component necessary for setting up a common, shared session of utilising said one of said proposed recreational applications,
e) as a response to receiving said first request in said recreational application server, transmitting the requested software component from said recreational application server to the first terminal arrangement,
f) as a response to receiving said second request in said recreational application server, transmitting the requested software component from said recreational application server to the second terminal arrangement and
g) exchanging a pair of messages between the first and second terminal arrangements indicating the readiness of utilising the recreational application.

20. A method according to claim 19, comprising between steps a) and b) the step of presenting said number of proposed recreational applications to the user of the second terminal arrangement, so that step b) is only executed as a response to receiving from said user an indication of acceptance concerning one of said number of proposed recreational applications.

21. A method according to claim 19, comprising after step g) the step of indicating to the users of the first and second terminal arrangements the readiness of utilising the recreational application.

22. A method according to claim 1, comprising the steps of:
a) transmitting from the first terminal arrangement to the second terminal arrangement a proposal for setting up a common, shared session of utilising a recreational application,
b) transmitting from the second terminal arrangement to the first terminal arrangement a proposal identifying a number of proposed recreational applications,
c) transmitting from the first terminal arrangement to the second terminal arrangement a request for obtaining a software component necessary for setting up a common, shared session of utilising one of said proposed recreational applications and
d) as a response to receiving said request in said second terminal arrangement, transmitting said software component from the second terminal arrangement to the first terminal arrangement.

23. A method according to claim 22, comprising between steps b) and c) the step of presenting said number of proposed recreational applications to the user of the first terminal arrangement, so that step b) is only executed as a response to receiving from said user an indication of acceptance concerning one of said number of proposed recreational applications.

24. A method according to claim 22, comprising after step d) the step of indicating to the users of the first and second terminal arrangements the readiness of utilising the recreational application.

25. A method according to claim 1, characterised in that the step of using the communicational capabilities of at least one of the first and second terminal arrangements to establish a state where both the first terminal arrangement and the second terminal arrangement possess enough software components for setting up a common, shared session of utilising said recreational application comprises the substep of
transmitting from the first terminal arrangement (1101) to the second terminal arrangement (1102) a complete copy (1105, 1106) of those software components (1103, 1104) which the first terminal uses for setting up a common, shared session of utilising said recreational application.

26. A method according to claim 1, wherein the step of using the communicational capabilities of at least one of the first and second terminal arrangements to establish a state where both the first terminal arrangement and the second terminal arrangement possess enough software components for setting up a common, shared session of utilising said recreational application comprises the substep of
transmitting from the first terminal arrangement to the second terminal arrangement a limited copy of those software components which the first terminal uses for setting up a common, shared session of utilising said recreational application, said limited copy being only usable for setting up a common, shared session of utilising said recreational application together with the particular first terminal arrangement in question.

27. A method according to claim 1, wherein the step of using the communicational capabilities of at least one of the first and second terminal arrangements to establish a state where both the first terminal arrangement and the second terminal arrangement possess enough software components for setting up a common, shared session of utilising said recreational application comprises the substep of:
transmitting from the first terminal arrangement to the second terminal arrangement a more advanced copy of those software components which the first terminal uses for setting up a common, shared session of utilising said recreational application.

28. A method according to claim 1, wherein the step of using the communicational capabilities of at least one of the first and second terminal arrangements to establish a state where both the first terminal arrangement and the second terminal arrangement possess enough software components for setting up a common, shared session of utilising said recreational application comprises the substeps of:
transmitting from the first terminal arrangement to the second terminal arrangement an authenticated offer for setting up a common, shared session of utilising said recreational application,
forwarding said authenticated offer from the second terminal arrangement to a recreational application server, and
transmitting from said recreational application server to the second terminal arrangement a limited copy of software components needed for setting up a common, shared session of utilising said recreational application, said limited copy being only usable for setting up a common, shared session of utilising said recreational application together with the particular first terminal arrangement in question.

29. A method according to claim 28, comprising the step of imposing a charge to the user of the first terminal arrangement for setting up a common, shared session of utilising said recreational application together with the particular second terminal arrangement in question.

30. A method according to claim 1, wherein the step of using the communicational capabilities of at least one of the first and second terminal arrangements to establish a state where both the first terminal arrangement and the second terminal arrangement possess enough software components for setting up a common, shared session of utilising said recreational application comprises the substeps of:
transmitting from the second terminal arrangement to the first terminal arrangement an authenticated offer for setting up a common, shared session of utilising said recreational application,
forwarding said authenticated offer from the first terminal arrangement to a recreational application server, and
transmitting from said recreational application server to the second terminal arrangement a copy of software components needed for setting up a common, shared session of utilising said recreational application.

31. A method according to claim 30, comprising the step of imposing a charge to the user of the second terminal arrangement for setting up a common, shared session of utilising said recreational application together with the particular first terminal arrangement in question.

32. A method according to claim 1, wherein the step of using the communicational capabilities of at least one of the first and second terminal arrangements to establish a state where both the first terminal arrangement and the second terminal arrangement possess enough software components for setting up a common, shared session of utilising said recreational application comprises the substeps of:
transmitting from the second terminal arrangement to the first terminal arrangement an authenticated offer for setting up a common, shared session of utilising said recreational application,
forwarding said authenticated offer from the first terminal arrangement to a recreational application server together with another authenticated offer from the first terminal arrangement for setting up a common, shared session of utilising said recreational application, and
transmitting from said recreational application server to the terminal arrangements copies of software components needed for setting up a common, shared session of utilising said recreational application.

33. A method according to claim 32, comprising the step of imposing charges both to the user of the second terminal arrangement for setting up a common, shared session of utilising said recreational application together with the particular first terminal arrangement in question and to the user of the first terminal arrangement for setting up a common, shared session of utilising said recreational application together with the particular second terminal arrangement in question.

34. A method according to claim 1, wherein the step of using the communicational capabilities of at least one of the first and second terminal arrangements to establish a state where both the first terminal arrangement and the second terminal arrangement possess enough software components for setting up a common, shared session of utilising said recreational application comprises the substeps of:
exchanging information between the first and second terminal arrangements through a short-distance communications connection during said common, shared session of utilising said recreational application, and
after the exchanging of information between the first and second terminal arrangements through said short-distance communications connection becomes impossible, deeming the common, shared session of utilising said recreational application to be ended.

35. A method according to claim 34, additionally comprising the substep of refraining from other exchange of information between the first and second terminal arrangements through said short-distance communications connection during said common, shared session than such information that is needed to ensure that the short-distance communications connection is still active.

36. A terminal arrangement comprising a terminal of a cellular radio system, comprising
means for exchanging proposals for setting up sessions of utilising a recreational application with other terminal arrangements and
means for responding to a situation where such proposals have been exchanged by using its communicational capabilities to establish a state where both it and another terminal arrangement possess enough software components for setting up a common, shared session of utilising said recreational application.
